(19) United States
(12) Patent Application Publication
(10) Pub. No.: US 2015/0203746 A1
(43) Pub. Date: Jul. 23, 2015

(54) Methods for using polymers in boron-laden fluids

(71) Applicant: ChemEOR, Inc., Covina, CA (US)

(72) Inventor: Carl Aften, Covina, CA (US)

(21) Appl. No.: 14/601,204

(22) Filed: Jan. 20, 2015

Related U.S. Application Data
(60) Provisional application No. 61/928,983, filed on Jan. 17, 2014.

(51) Int. Cl. C09K 8/88; E21B 43/25; C09K 8/90; E21B 43/267

(52) U.S. Cl. CPC C09K 8/887; E21B 43/267; E21B 43/25; C09K 8/905

(57) ABSTRACT

Methods for treating a subterranean formation adjacent a wellbore using a boron-laden fluid, comprising obtaining a treatment fluid comprising the boron-laden fluid and a hydratable non-galactomannan polymer; and injecting the treatment fluid into a borehole to contact at least a portion of the subterranean formation; and related compositions thereof.

This application claims the benefit of and hereby incorporates by reference herein U.S. Provisional Application No. 61/928,983 filed on Jan. 17, 2014.

Methods and related compositions disclosed herein relate to adding hydratable polymers to fluids for viscosification, and more particularly, to using non-galactomannan polymers to viscosify boron-laden fluids.

Fluids for fracturing and other treatment operations in hydrocarbon production and recovery are viscosified by polymeric gelling additives that are crosslinked in order to carrying sand or other types of proppants. The polymers can also perform as uncrossed linear gels. In certain operations, fluids without or with low gelling additives are pumped at relatively higher rates (>60 bbl/min) in so-called slickwater operations. It is very desirable that gelling and other additives, if used, should be completely recovered or leave minimum residues in the formation once proppants have been placed, so as not to lead to formation damage due to plugging. Gelling additives are generally polymers, either natural, plant-based ones such as guar gum and cellulosics and their derivatives, or synthetic ones including polyacrylamide-based polymers. Because all fracturing operations use large volumes of water or water-based fluids, there are strong incentives to recycle or reuse water.

Basic processes for producing hydrocarbons using hydraulic fracturing, which have been practiced for several decades. Such processes are prevalent in the development of shale and other unconventional hydrocarbon resources in the U.S. and elsewhere, and are well known in the art. Briefly, these processes involve pumping fluids down a wellbore connected to a hydrocarbon reservoir within a rock formation. Fluids are pumped at high pressure for a relatively short period of time (hours) to create fractures extending from the wellbore for up to several hundred feet, or to connect pre-existing fractures/pockets/flow pathways in the rock formation. The same pumped fluids at the same time transport proppants downhole to fill the fractures and form permeable packs, which prop open the fractures and enable conductive pathways for hydrocarbon flow back into the wellbore, once pressure is released. High viscosity fluids serve to assist opening fractures and to prevent settling of proppants if used. Settling can cause very serious line plugging, premature screenout, and solid handling problems. Fluids pumped downhole must be recovered and sometimes the well flushed to maximize hydrocarbon flow, and if viscosified, broken to enable recovery and minimize formation damage.

Typically approximately 4 to 6 million gallons of water are used per treatment. Cost incurred is associated with both transporting and (post-treatment) processing the water to comply with environmental regulations, being about USD 0.75-1.00/gal for the latter. Produced water can contain hydrocarbons/condensates such as methane, ethane, and propane, suspended solids, bacteria, naturally occurring radioactive materials (NORM) such as radium isotopes, and up to 300,000 mg/L total dissolved solids (TDS). Produced water usually requires processing, from a considerable extent to minimally, to be reused for stimulation, fracturing, and other treatment operations. Processed produced water can be directly used or blended with fresh water for use. In certain areas, scarcity of fresh water necessitates the reuse or recycling of produced water.

Produced water is water produced along with oil and/or gas, consisting generally of formation water, flowback fluids, surface water, and water from any other sources. Formation water is water rich in brine from the targeted hydrocarbon-rich rock. This briny water may be ancient seawater trapped in the formation or previously injected water that has dissolved formation minerals, such as barium, calcium, magnesium, and iron, and flowing back as salty water. In general, flowback water is a mixture of fracturing fluid and formation water. Once the chemistry of the water coming out of a well resembles that from the rock formation more closely than the fracturing fluid, it is known as produced water and can continue to flow as long as a well is in operation. In the Marcellus shale, as an example, most of the flowback occurs in the first seven to ten days, while the rest can occur over a three to four week time period. The recovery volume is anywhere between 20% and 40% of the volume that was initially injected into the well. In contrast, produced water flows to the surface throughout the lifespan of a well. The transition point from flowback to produced water can be difficult to discern, but is sometimes identified according to the rate of return measured in barrels per day (bpd) and chemical composition analysis. Flowback water produces higher flow rate over a shorter period of time, greater than 50 bpd. Produced water produces lower flow over a much longer period of time, typically from 2 to 40 bpd. The chemical composition between the two can be very similar. Other sources of water used in well treatment operations include surface water, underground water, and underground aquifer water.

High levels of boron can occur in produced and flowback water, as well as in certain surface, underground, and underground aquifer water. Natural causes exist for this high level. In the case of produced and flowback water, however, a major boron source is boron supplied in the fracturing fluid composition as a crosslinker, other types of which include zirconium, titanium, and aluminum. Produced water from the Bakken formation can have a boron concentration greater than 300 mg/L, or even routinely up to 425 mg/L (Gupta, D. V. et al., SPE 159837, Society of Petroleum Engineers (2012); Kakadjian, S. et al., SPE 167275, Society of Petroleum Engineers (2013)). Analysis of ion contents in 36 flowback fluids from the west Texas region shows boron levels to be between 1 to 192 mg/L (Haghshenas, A. and Nasr-El-Din, H. A., SPE 169408, Society of Petroleum Engineers (2014)).

Crosslinkers are used to crosslink gelling agents, and are introduced at a specific time point after a polymer gelling agent has been hydrated. The galactomannan natural polymer guar gum accounts for as much as 80% of the gelling agents used in fracturing fluids. Boron/borate crosslinkers remain the predominant type used for guar crosslinking Boron present even at low concentrations, however, has been found to interfere with guar's ability to perform properly or effectively as a viscosifying agent and/or to crosslink fluids. (The term “boron” as used herein refers either loosely to boron-based crosslinkers, or to all boron species in a solution/dispersion/suspension derived from boron compounds, especially boric acid and salts thereof, particularly borax or sodium (tetra)borate salts, as will be clear from context. While the expression “boron/borate” refers to all boron species present in a solution/dispersion/suspension derived from boron compounds, some of which may be in the form of borate, formally B₄O₇²⁻, depending on pH and the source of compounds, which have various crystal water content. Borax is generally taken to dissociate formally to equal amounts of boric acid and borate in an aqueous medium as follows: B₄O₇²⁻+7H₂O<->2B(OH)₃+2B(OH)₄⁻. As used herein, the expressions “borate” or “boric acid/borate” refers to the following: that as a crosslinker for guar gels, this species is often understood to exist as a tetra-coordinated complex, alone as B(OH)₄⁻ formally, or with hydroxyls from the guar polymer chains participating as chelating ligands, replacing some or all four of the hydroxyls in the B(OH)₄⁻ complex, and upon such replacement sometimes forming borate esters of the form B(OH)₂(OR₁)(OR₂)⁻, for example, where R₁ and R₂ extend from the same or different chains of polymer molecules. It is understood that certain references interpret boric acid as a tribasic Bronsted acid. U.S. Pat. No. 6,844,296 discloses several examples of suitable borate compounds and forms that borate crosslinking agent may assume when used.)

Crosslinking also occurs between guar and polyvalent metal complexes (complex metal ions), e.g., those of titanium, zirconium, hafnium, aluminum, and chromium. But the guar/borate chemistry gives gels which viscosity under mechanical shear is reversible, whereas metal complex crosslinked bonding, though stronger, is generally not shear reversible. For borate crosslinkers, crosslinking is reversible when the pH of the fracturing fluid declines to below about 7.5, permitting relatively easier removal of the fracturing fluid after completion of a well treatment and leading to relatively higher fracture conductivity, compared to metal complex crosslinking agents such as zirconium-based ones. For these reasons, boron/borate crosslinkers are in many instances preferred, and remain the predominant type used for guar crosslinking, introduced at a concentration ranging from about 5 ppm to about 500 ppm.

In such instances, however, although boron is used and indeed required for boron/borated crosslinked fluids, if boron were initially present in a base fluid, it adversely affects the viscosifying and crosslinking processes. This may be because meta-stable structures and assemblies are formed in a guar slurry made with boron-laden fluid. The presence of such meta-stable structures interferes with and prevents the controlled introduction of boron, and the controlled crosslinking of fracturing fluid gels. The problem presents itself acutely when reusing produced and flowback water containing treatment or fracturing fluids viscosified by the guar/borate system is attempted. Therefore a solution is required to effectively make use of produced and flowback water and all types of boron-laden fluids as the base fluid or carrier of treatment or fracturing compositions.

Natural polymers, especially hydratable polysaccharides, are used whether or not crosslinked as gelling agents in treatment operations. Suitable hydratable polymers include anionically substituted galactomannan gums, guars, guar gum derivatives, locust bean gum, gum karaya, and cellulose derivatives such as carboxymethyl cellulose (CMC), carboxymethyl hydroxyethyl cellulose (CMHEC), and hydroxyethyl cellulose (HEC) substituted by other anionic groups. As used herein when describing polysaccharide carbohydrates, “sugar” or “sugar unit” and their plurals refer, unless defined or it is clear by context otherwise, to simple sugars and, more specifically monosaccharides, which are monomers constituting the polysaccharide polymers.

Any and all of the free hydroxyls on the simple sugars of a polymer can be reacted in derivatization reactions. Two concepts are used to characterize derivatization. Molar substitution (MS), a ratio, expresses the number of moles of propylene oxide bonded to the polymer per mole of polymer, in the case of derivatizing guar to HPG with propylene oxide and base for example, and similarly for other hydroxyalkyl derivatization; it can be quantified by GC or NMR after wet chemical titrations. And degree of substitution (DS) describes the average number of hydroxyls substituted per sugar. Each repeating subunit of guar or a guar derivative is taken to consist of three simple sugar units, two mannoses and one galactose. Therefore nine hydroxyls, not evenly distributed three per sugar, are available for derivatization in each subunit, leading to a theoretical maximum DS of 3. The cellulose polymer comprises glucoses as repeating subunits, each of which contains three free hydroxyls, leading to a theoretical maximum DS of 3 also.

It has been proposed that borate chelation is more effective if ligands are from two pairs of cis sugar hydroxyls. The mannose C-2 and C-3 cis hydroxyls have been suggested to contribute to chelation, as have the galactose C-3 and C-4 hydroxyls (Bishop, M. et al., Dalton Transactions: 2621-34 (2004)). However, the galactose C-4 and non-chiral C-6 hydroxyls have also been suggested (Montgomery, C. “Fracturing Fluid Components” in: Bunger, P. et al. (ed.), Effective and Sustainable Hydraulic Fracturing, 2013). Upon derivatizing by hydroxyalkyl groups, the number of hydroxyl groups available for chelation is reduced. Hydroxyalkylation processes, however, do not distinguish between cis and trans positions per se. Derivatizing by carboxymethyl groups makes available carboxyls (or carboxylates) for chelation, likely by covalent bonding, at least to metal crosslinkers such as zirconate. All free hydroxyls on simple sugars, including hydroxyl functions of previously hydroxyalkylated substituents, can react during carboxymethyl and similar carboxyalkyl derivatizations.

Cellulosic gelling agents have glucoses as main chain building blocks, which C-2 and C-3 hydroxyls are in a trans orientation. The glucose sugars of cellulose can also be carboxymethylated, for example, leading to carboxymethyl cellulose (CMC) and its sodium salt, or otherwise carboxyalkylated. Good water solubility and other desirable physical properties of CMC are obtained at a degree of substitution lower than 3. Ashland Inc., for example, supplies the Aqualon® series of CMC where a widely used type has a DS of 0.7. Higher DS, up to about 1.5, can result in CMC products with improved compatibility with other soluble components. CMC and other cellulose ethers are usually crosslinked with metal complex crosslinkers such as zirconium- and titanium-based ones. But cellulosic polymers and crosslinked cellulose polymers can complex with boron/borate, and in both monochelate and bischelate forms (Shao, C. et al. Macromolecules 33: 19-25 (2000); Miyazaki, Y. et al., J. Ion Exchange 14: Suppl. 33-36 (2003)), and oxidized CMC can be complexed and/or crosslinked by borate (Balakrishnan, B. et al., J. Mater. Chem. B 1: 5564-77 (2013)).

Although boron/borate crosslinkers remain the predominant type used for guar crosslinking, and are thus routinely introduced to formulate treatment fluids, it is impractical, difficult, or expensive to remove boron or borates from water sources supplying oil production and servicing sites. Often such sites are remote, and for production and servicing purpose it is most desirable to use water from the nearest suitable source, since trucking large quantities of water over distance is logistically inconvenient or costly. Sometimes produced water is recycled.

At the same time, water sources near oil and gas production sites have been increasingly found to be borate laden or rich. Such sources are sometimes the only available local ones for a stimulation or production project. It would also be very desirable for environmental reasons to make use of produced water more effectively such that the crosslinking process could be controlled and impervious to the boron or borate levels of the water source.

Thus there exists a need in the industry to make use of boron or borate-laden water to form crosslinked gels in a predictable and well-controlled manner for stimulation projects. We have found that very surprisingly non-galactomannan polymers, including cellulosic polymers such as carboxymethyl cellulose, can form crosslinked gels in a predictable and well-controlled manner using borate-laden fluids as an aqueous base.

### SUMMARY

Disclosed herein are methods for treating a subterranean formation adjacent a wellbore using a boron-laden fluid, comprising obtaining a treatment fluid comprising the boron-laden fluid and a hydratable non-galactomannan polymer; and injecting the treatment fluid into a borehole to contact at least a portion of the subterranean formation. The disclosure may be more readily understood by reference to the following description of the preferred embodiments and various features of the invention and examples included therein as well as drawings.

### BRIEF DESCRIPTIONS OF THE DRAWINGS

FIG. 1 is a graph showing the viscosity at several time points of guar solutions at several boron concentrations.

FIG. 2 is a graph showing the viscosity at several time points of CMC solutions at several boron concentrations.

FIG. 3 is a graph showing the viscosity development over time of crosslinked guar and CMC solutions at several boron concentrations.

### DESCRIPTION OF THE PREFERRED EMBODIMENTS

Embodiments of the invention provide methods of treating a subterranean formation, delivering proppants, and viscosification using boron-laden fluids, and associated compositions thereof. The methods generally relate to combining a base fluid and hydratable polymers that are non-galactomannan polymers. We have found that such a process, unexpectedly, can be carried out using boron-laden base fluids, and nevertheless achieve the purposes stated. Advantageously, methods provided here enable fluids that are boron-rich either naturally or due to previous intentional introduction of boron to be reused or recycled. The ability to use directly boron-laden fluids avoids boron removal treatment processes, and is particularly helpful in situations when fresh water is scarce or unavailable. In certain embodiments, the non-galactomannan polymer used is a cellulosic polymer. While some advantages are disclosed, not all advantages will be discussed herein.

In one embodiment, a boron-laden fluid is a fluid comprising boron, where boron refers to all boron species in a solution/dispersion/suspension derived from boron compounds, especially boric acid and salts thereof, particularly borax or sodium (tetra)borate salts. Some of the boron compounds may be in the form of borate, formally B₄O₇²⁻, depending on pH and the source of compounds, having various crystal water contents, or be in the form of borate esters. Some of the boron compounds may have been introduced to the fluid as a boron-based crosslinker. U.S. Pat. No. 6,844,296 discloses several examples of suitable borate compounds and forms that borate crosslinking agent may assume when used, and is hereby incorporated by reference with respect to these aspects. “Boron-laden” means a boron concentration in a fluid that is at least several ppm (mg boron per L fluid). In certain embodiments, boron may be present at a concentration of at least about 10 ppm, at least about 20 ppm, at least about 30 ppm, at least about 40 ppm, at least about 50 ppm, at least about 60 ppm, at least about 70 ppm, at least about 80 ppm, at least about 90 ppm, at least about 100 ppm, at least about 200 ppm, at least about 300 ppm, at least about 400 ppm, or at a minimum value between any of these values.

In a particular embodiment, the boron-laden fluid comprises at least a portion of at least one of the following: a surface water, an underground aquifer water, a formation water, a produced water, and a flowback water. In certain embodiments, the boron-laden fluid is substantially free of large suspended solids, i.e., free of solids at least about 0.5, or at least about 1 micron in diameter, which can be removed by sedimentation or filtration, for example, or other processes. In one embodiment, the boron-laden fluid is substantially free of hydrocarbon and/or oil condensates, i.e., where hydrocarbon and/or oil condensates account for no more than approximately 1% of the fluid, where a condensate is an ultralight oil sometimes defined as having an API gravity above 45.

The hydratable non-galactomannan polymer can be cationic or anionic. Preferably, it is an anionic polymer, such as a carboxymethyl-substituted cellulose polymer with a degree of substitution (DS) of carboxymethyl groups (CM), or CM(DS), of preferably at least about 0.6. In certain embodiments, the CM(DS) is from about 0.70 to about 1.20. The CM(DS) can be about 0.70, about 0.75, about 0.80, about 0.85, about 0.90, about 0.95, about 1.0, about 1.05, about 1.10, about 1.15, or about 1.20, or any range between any two of these values. Polymers with a CM(DS) outside of these ranges may also be used in embodiments of the invention. In addition to ionic substitution, a suitable polymer may optionally include one or more neutral groups, such as hydrocarbyl groups. In certain embodiments, the hydratable non-galactomannan polymer is carboxymethyl cellulose, salts thereof, or mixtures thereof.

Suitable anionic groups include, but are not limited to carboxylate groups, carboxylalkyl groups, carboxylalkyl hydroxyalkyl groups, sulfate groups, sulfonate groups, amino groups, amide groups, or any combination thereof. An alkyl group includes any hydrocarbon radical, such as methyl, ethyl, propyl, butyl, pentyl, hexyl, heptyl, octyl, etc. Suitable cationic groups for attachment to the polymer include, but are limited to, quaternary ammonium groups. Typical of quaternary ammonium groups are methylene trimethylammonium chloride, methylene trimethylammonium bromide, benzyltrimethylammonium chloride and bromide, and the like, wherein each of the groups is derivatized in the form of a radical which is substituted in a hydrocolloid gelling agent by means of an alkylene or oxyalkylene linkage. Examples of commercially available cellulose ethers with one or more substituted cationic quaternary ammonium groups include the UCARE Polymers series (from Dow Chemical Company) and the Celquat® family series (from Akzo Nobel). Other suitable cationic groups such as acid salts of primary, secondary, and tertiary amines, sulfonium groups or phosphonium groups.

Suitable hydratable polymers that may be used in embodiments of the invention include any of the hydratable non-galactomannan (or non-polygalactomannan as an alternative description) polysaccharides that are capable of forming a gel in the presence of a crosslinking agent and have hydrophilic or anionic moieties extending from the polymer backbone. For instance, suitable hydratable polysaccharides include, but are not limited to, substituted or anionically substituted non-galactomannan gums and cellulose ethers, and hydroxyalkylated and alkylated cellulose ethers. Specific examples are anionically substituted locust gum and karaya gum, carboxymethyl cellulose (CMC), carboxymethyl hydroxyethyl cellulose (CMHEC), hydroxyethyl cellulose (HEC) substituted by other anionic groups, hydroxyalkylated, alkylated, and un-substituted, hydroxypropyl cellulose (HPC), and methyl cellulose (MC) hydroxyalkylated. Additional hydratable polymers may also include sulfated or sulfonated and cationically derivatized non-galactomannan polymers, and synthetic polymers with anionic groups, such as polyvinyl acetate, polyacrylamides, poly-2-amino-2-methyl propane sulfonic acid, and various other synthetic polymers and copolymers. Hydrophobically modified polymers may be used in embodiments of the invention with or without modification; exemplary is Natrosol Plus (from Ashalnd Inc.), an HEC modified with a long-chain alkyl group, also termed hydrophobically modified hydroxyethyl cellulose (HMHEC). Other suitable polymers include those known or unknown in the art.

In one embodiment, the hydratable non-galactomannan polymer is a cellulosic polymer, or more specifically cellulose ethers, which are a class of polymers resulting from alkylation of cellulose and providing rheology control. As used herein, cellulose ethers are included within the scope of the term “cellulosic derivatives.” Cellulose ethers include, but are not limited to, sodium carboxymethyl cellulose (CMC), hydroxyethyl cellulose (HEC), and hydroxypropyl methyl cellulose (HPMC). They can be made by reacting under heterogeneous conditions purified cellulose with alkylating agents. This is usually carried out in the presence of a base, for example sodium hydroxide, and sometimes other reagents. Crude grades are dried, ground, and packed out, while purified grades require byproduct removal prior to drying. Various additives such as colloidal silicas can be added in small quantities to improve dry handling properties. Molecular weight reduction by hydrogen peroxide, controlled alkaline-catalyzed auto-oxidation with oxygen, or acid hydrolysis may be included at any of several points in the manufacturing process. Cellulose ethers can be supplied as dry powers or granules or fluidized suspensions or water solutions. In certain embodiments, the cellulose ethers are water soluble (in hot or cold water) or hydratable, having DS values between about 0.40 and about 2.0, and if they are hydroxyalkyl ethers having MS values between about 1.5 and 4.0. It is understood that at even at the same or similar DS, distribution of substituents, i.e. extent of substituent uniformity or block-like presentation along the polymer chain, influences solution thixotropy. In particular embodiments, cellulosic polymers are cellulose ethers containing mixed substituents (i.e., cellulose mixed ethers). In a particular embodiment, the cellulosic polymer is the cellulose mixed ether carboxymethyl hydroxyethyl cellulose (CMHEC), tolerant of mono- and divalent metal ions in solution but crosslinkable with tri- or tetravalent ions to give viscoelastic gels. Advantageously, there are no adverse toxicological or environmental factors reported for cellulose ethers in general.

Generally, for cellulose ethers, manufacturers specify solution viscosity data and not polymer molecular weight (MW). But MW can be estimated from relationships such as the Mark-Houwink equation. However, in certain embodiments, MW for CMC can be from about 90,000 to about 700,000, MW for HEC can be from about 90,000 to about 1,300,000, and MW for HPC can be from about 80,000 to about 1,200,000.

In certain embodiments, high MW grade CMC polymers have viscosities in non-boron-laden water up to about 12,000 cP at 1% solids (on a Brookfield LVT viscometer at 30 rpm), and lower MW CMC polymers have viscosities in non-boron-laden water of about 50 cP at 4% solids. CMC polymer solutions can be pseudoplastic or thixotropic depending on MW, DS, and manufacturing process, and embodiments can be used and maintain stability in a wide range of pH, between about 7 and about 9, greater than about 10, down to about 4, and lower than about 4. In particular embodiments, boron-laden fluids can comprise water-miscible solvents such as ethanol and acetone, in which mixtures CMC is soluble. In an embodiment, boron-laden fluids of the invention comprise any of various other water-soluble non-ionic gums over a wide range of concentrations with which CMC is compatible. In particular embodiments, such other water-soluble non-ionic polymers are HEC or HPC, and a synergistic effect in viscosity with CMC can be observed such that the viscosity is considerably higher than would be expected.

In one embodiment, the cellulosic polymer of the invention is HEC, having a hydroxyethyl MS value of about 1.5 or greater, and more specifically between about 1.8 and about 3.5. Advantageously, boron-laden fluids with which the HEC is combined can contain high levels of salts, for example up to 10% or up to 50% sodium chloride or aluminum nitrate. In a particular embodiment, the HEC used is surface treated with for example glyoxal. In another embodiment, the cellulosic polymer is CMHEC, having a CM(DS) between about 0.3 and about 0.5, and a hydroxyethyl MS of between about 0.7 and about 2.0, and soluble in high salt fluids, such as saturated sodium chloride solutions, and tolerant of calcium ions and seawater. In a particular embodiment, CMHEC may be crosslinked with trivalent cations, such as Al³⁺ and Fe³⁺, or other multivalent cations to give greatly increased viscosity or viscoelastic gels capable of suspending and transporting proppants into a wellbore. In one embodiment, the cellulosic polymer is the water-soluble ethyl hydroxyethyl cellulose (EHEC) having an ethyl DS of about 1.0 and a hydroxyethyl MS of about 2.0 or greater, or HMHEC, both having increased surface activity such as lowering surface and interfacial tensions. In a particular embodiment, HMHEC stabilizes oil-in-water emulsions without the use of high HLB surfactants. In certain embodiments, the hydratable cellulosic polymer is methyl cellulose (MC) or one of its alkylene oxide derivatives, such as hydroxypropyl MC (HPMC), hydroxyethyl MC (HEMC), and hydroxybutyl MC (HBMC), which are non-ionic, surface active polymers; in these embodiments, MC can have a DS of between about 1.4 and about 2.4, while DS for HPMC, HEMC, HBMC can be about 1.1-2.0, 1.3-2.2, and at least about 1.9, respectively, where hydroxyalkyl MS are about 0.1-1.0, 0.06-0.5, and at least greater than about 0.04. In certain embodiments, the hydratable cellulosic polymer is HPC, having a MS greater than about 3.5, capable of achieving 3000 cP at 1% total solids in non-boron-laden water, and exhibiting organic solvent solubility (for example methanol, ethanol, and propylene glycol), thermoplasticity, and surface activity.

Also advantageously and in an aspect, cellulosic polymers, including CMC, can be manufactured to contain relatively little or lower insoluble solid residues (to less than about 1% by weight) compared to guar and guar derivatives, and break more cleanly using typical oxidant breakers, such as ammonium persulfate, employed in oil and gas treatment operations, permitting high regain reservoir conductivity, to greater than about 80%, and in certain embodiments greater than about 90%. In a particular embodiment, cellulosic polymers used as powder or granules have good flowability, possessing an angle of repose of no more than about 40, about 39, about 38, about 37, about 36, about 35, or a maximum value between any of these values.

The hydratable non-galactomannan polymer, including cellulosic polymers such as CMC, of the present embodiments should be included in the boron-laden treatment, viscosified, or proppant-delivery fluids in an amount sufficient to provide the desired viscosity characteristics. In some embodiments, the hydratable non-galactomannan polymer may be present in an amount in the range of from about 35 pptg (pound per thousand gallon of base fluid) to about 80 pptg. The polymer can be present at about 40 pptg, about 45 pptg, about 50 pptg, about 55 pptg, about 60 pptg, about 65 pptg, about 70 pptg, about 75 pptg, about 80 pptg, or at any range between any two of these values. In some embodiments, a hydratable polymer may be present in an amount ranging from about 30 pptg to about 60 pptg. A 35 pptg loading is taken to be equivalent to 0.42% wt/vol. It is understood that a non-galactomannan polymer such as CMC has a different loading range than a galactomannan polymer such as guar to achieve a similar viscosity in non-boron-laden fluids.

In one embodiment, methods for treating a subterranean formation adjacent a wellbore using a boron-laden fluid comprise: obtaining a treatment fluid comprising the boron-laden fluid and a hydratable non-galactomannan polymer; and injecting said treatment fluid into a borehole to contact at least a portion of the subterranean formation.

In another embodiment, a method for treating a subterranean formation may further comprise: adding to the treatment fluid a crosslinking agent; and crosslinking the polymer to form a crosslinked fluid using said crosslinking agent, wherein, optionally, a crosslinking delaying agent delaying the crosslinking between the crosslinking agent and the polymer can be added. In certain embodiments, the crosslinking agent is at least one of a zirconium-based and a titanium-based agent. The amount of crosslinking agent used depends on the well conditions and the type of treatment to be effected, but is generally in the range of about 10 ppm to about 1000 ppm of metal ion of the crosslinking agent in the treatment fluid/solution containing the hydratable polymer. In certain applications of the embodiments, the aqueous polymer solution is crosslinked immediately upon addition of the crosslinking agent to form a viscous gel, while in others, the reaction of the crosslinking agent can be delayed/retarded so that viscous gel formation does not occur until a desired time. In one embodiment, the subterranean formation treatment method further comprises adding to the treatment fluid a breaking agent for breaking the crosslinked fluid.

Any crosslinking agent, crosslinking delaying agent, or breaking agent suitable for a fluid system comprising a non-galactomannan polymer, including a cellulosic polymer, can be used in the embodiments, examples of which agents disclosed in the art include those from U.S. Pat. No. 7,732,382, U.S. Pat. No. 8,158,562, and U.S. Pat. No. 8,853,135, all hereby incorporated by reference in their entirety herein. Those of ordinary skill in the art, with the benefit of this disclosure, will know the type and quantity of crosslinking, crosslinking delaying, and breaking agents to use to implement the methods of the present invention.

In one embodiment, the crosslinked fluid maintains a viscosity of about 500 cP or greater subject to typical near wellbore shear rates. Shear rates in the near wellbore region and fractures vary, but an accepted range in the art is from about 1 s⁻¹ to about 100 s⁻¹, or from about 40 s⁻¹ to about 100 s⁻¹, though rates can sometimes be several hundred per sec. However, above about 80 s⁻¹, performance of fluids of typical compositions often may not vary significantly. Fluids of the invention viscosified by non-galactomannan polymers are pseudoplastic or shear thinning, and sometimes also thixotropic, and decrease in viscosity at higher shear rates. In illustrative examples below, crosslinked fluids were sheared at 100 s⁻¹ or 40 s⁻¹. At shear rates lower than these values, viscosity is expected to be higher than at these values. It is desirable that an achieved viscosity be maintained (until broken by design) for at last about 60 min, more preferably longer than about 120 min, or about 180 min. In certain embodiments, the crosslinked fluid subject to typical near wellbore shear rates maintains a viscosity of at least about 600 cP, or at least about 700 cP, or at least about 800 cP, or at least about 900 cP, or at least about 1000 cP, or at least about 1200 cP, or at least about 1400 cP, or at least about 1600 cP, or at least about 1800 cP, or at least about 2000 cP, or at a minimum value between any of these values.

In one embodiment, methods for viscosifying a boron-laden fluid are provided, comprising: providing the boron-laden fluid; and contacting the fluid with a hydratable non-galactomannan polymer to form a base gel. A base gel is a linear gel or an uncrossed gel, having a viscosity greater than that of the base fluid or water without the polymeric gelling additive or agent. In exemplary embodiments, methods for viscosifying a boron-laden fluid may further comprise: adding to the treatment fluid a crosslinking agent; and crosslinking the polymer to form a crosslinked fluid using said crosslinking agent, wherein, optionally, a crosslinking delaying agent delaying the crosslinking between the crosslinking agent and the polymer can be added. In certain embodiments, the boron-laden fluid provided that is to be viscosified has a boron concentration of at least about 10 ppm, or about 20 ppm, or about 30 ppm, or about 40 ppm, or has a minimum value of between any of these values; and the hydratable non-galactomannan polymer is CMC, salts thereof, or mixtures thereof.

In one embodiment, methods of delivering proppants using a fluid base that is boron-laden are provided, comprising: providing a boron-laden fluid; viscosifying the boron-laden fluid by contacting said fluid with a hydratable non-galactomannan polymer and a crosslinking agent, forming a crosslinked fluid; suspending the proppants with the crosslinked fluid, wherein the crosslinked fluid is pumped into a wellbore adjacent to a subterranean formation; and transporting the proppants to fractures formed by the crosslinked fluid within the formation. In certain embodiments, various additives including, but not limited to, biocides, breakers, buffers, clay stabilizers, diverting agents, fluid loss additives, friction reducers, iron controllers, surfactants, and gel stabilizers, may be also added to or present in the boron-laden base fluid.

In one embodiment, a viscosified composition is formed according to method embodiments for viscosifying a boron-laden fluid disclosed herein and comprises the boron-laden fluid; a hydratable non-galactomannan polymer; and a crosslinking agent.

While the methods and compositions described herein are not limited to reservoirs of a given temperature, they are particularly useful in reservoirs having an ambient temperature ranging from about 10° C. to about 120° C., and especially from about 20° C. to about 80° C.

In order to demonstrate that methods of the present invention are effective in viscosifying boron-laden fluids and achieving the other recited purposes, fluid compositions were prepared using hydratable polymers, and their viscosities measured and compared in the following examples. These examples are not intended to limit or define the entire scope of the invention.

### EXAMPLES

Table 1 presents conditions and parameters for several experiments constituting the examples. Notes: (a) For loading, %=wt/vol %.

TABLE 1

| Expt | | | | Shear rate | Boron |
|---|---|---|---|---|---|
| # | Polymer | Polymer loading | Crosslinker | (s⁻¹) | (ppm) |
| 1 | Guar | 20 pptg (0.24%) | None | 511 s⁻¹ | 0 (2 pHs), |
| | | | | | 10, 20, 40 |
| 2 | CMC | 20 pptg (0.24%) | None | 511 s⁻¹ | 0 (2 pHs), |
| | | | | | 10, 20, 40, |
| | | | | | 200 |
| 3 | Guar | 30 pptg (0.36%) | Borate | 100 s⁻¹ | 0, 20, 200 |
| 4 | CMC | 60 pptg (0.72%) | Zirconium | 100 s⁻¹ | 0, 20, 200 |
| 8 | HEC | 2% wt/vol | None | 10 rpm/ | 0, 200 |
| | | | | Brookfield | |

Procedure. Linear or base gels were made and tested as follows: A base fluid of deionized (DI) water without boron or with several levels of boron (to 10, 20, 40, 200 ppm boron equivalents) was prepared, and adjusted to pH 9 with NaOH; while stirring the base fluid (600 mL) in a Waring blender at 2000 rpm, 1.44 g of a biopolymer powder being tested was carefully added to a concentration of 20 pptg (0.24% wt/vol), and stirred for 2 min, forming a gel solution; 250 mL of this gel solution was transferred to an appropriately sized plastic sample cup for viscosity measurements on a Fann35 viscometer at 511 s⁻¹ at various time intervals; this procedure was carried out at room temperature. When the effect of boron was tested, boron was added first to DI water in the form of boric acid at desired concentrations.

Procedure cont. CMC was crosslinked and its viscosity measured as follows: 3.6 g of CMC [CMC995, substitution etc.] was weighed into 500 mL of a sodium acetate/acetic acid buffered base fluid, pH 4.5-5.0, stirring at 2000 rpm in a Waring blender, and allowed to stir for 10 min, forming a base gel; a Grace 5600 rheometer was set to a shear rate of 100 s⁻¹, a temperature of 175° F., and a monitoring time of 120 min; 0.6 mL of a zirconium crosslinker was added and allowed to stir for 30 sec; 52 mL of the solution was quickly drawn with a syringe and transferred to a Grace M5600 rheometer sample cup, which is positioned onto the instrument; after zeroing shear stress and setting pressure to 400 psi, viscosity was monitored according to set parameters. Boron as diluted boric acid was first added to the base fluid at desired levels when its effect was tested. For the cellulosic HEC, its viscosity in the absence and presence of a zirconium crosslinker was measured in a similar manner.

Procedure cont. Guar was crosslinked with borate and its viscosity measured as follows: 2.16 g powder was weighed and added quickly to 600 mL of DI water stirring in a Waring blender at 2000 rpm; after 5 min, 250 mL of this base gel solution was transferred to a plastic sample cup, which was then placed into a cage stirrer and set to stir at 1000 rpm; 0.5 mL of a delay agent and then 1.25 mL of borate crosslinker were added and mixed for 1 min, after which pH was adjusted to be greater 9; 52 mL of the solution was quickly drawn with a syringe and transferred to a Grace M5600 rheometer sample cup; after zeroing shear stress, the cup was positioned and pressure set to 400 psi and measurement initiated after 3 min 40 sec on the M5600, for 120 min of monitoring at 175° F., at a steady shear rate of 100 s⁻¹. When the effect of boron was tested, it was first added to DI water as appropriately diluted boric acid to achieve desired levels. When guar was crosslinked with zirconium, the same zirconium crosslinker used for CMC was used, but at 10% the concentration as that used for CMC, as otherwise the guar gel over-crosslinked.

Procedure cont. The guar derivatives CMHPG and CMG were crosslinked using zirconium crosslinkers in procedures similar to that used for guar except for the following differences: for CMHPG, pH during crosslinking was adjusted to 4-5 using acetic acid/sodium acetate and test run at 200° F.; for CMG, testing temperature, pressure, and shear rate were 253° F., 450 psi, and 40 s⁻¹; for both, a zirconium crosslinker was used without a delay agent.

Notes on procedures: Weighing balances are accurate to +/−0.001 g; when the Grace M5600 rheometer was used, it was first preheated to about 15° F. below the monitoring temperature for 30-60 min.

### Example 1

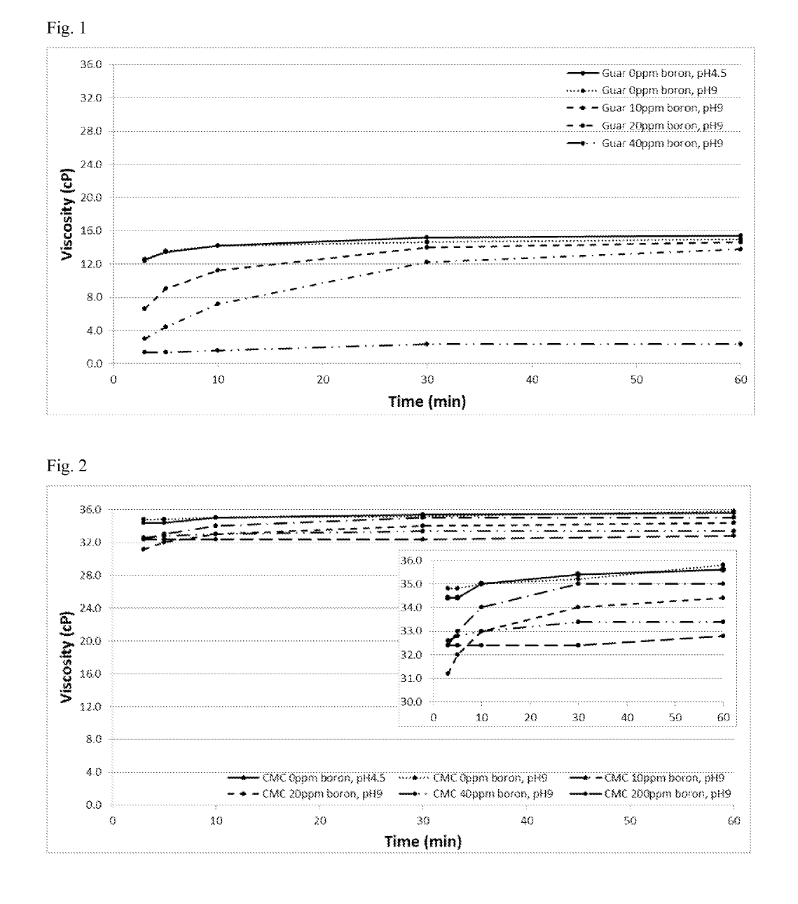

Experiment 1 series constitute Example 1. Results are presented in FIG. 1, and show that viscosities of linear guar gels are negatively influenced by presence of boron at low concentrations.

### Example 2

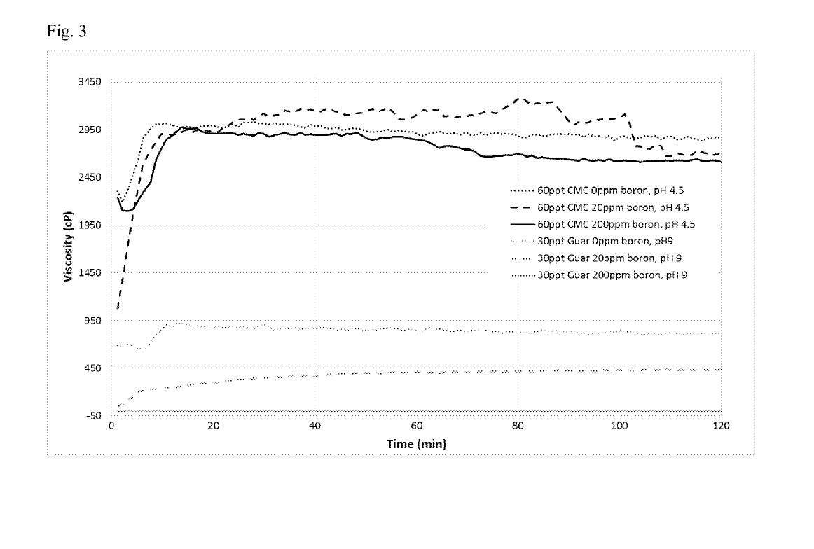

Experiment 2 series constitute Example 2. Results are presented in FIG. 2. They show that linear gels of CMC are not significantly influenced by the presence of boron even up to high concentrations.

### Example 3

Experiments 3 and 4 constitute Example 3. Results presented in FIG. 3 show that viscosity development for borate-crosslinked guar gels is noticeably negatively impacted by boron at a low concentration, and completely destroy at a high boron concentration. However, viscosity development for zirconium-crosslinked CMC is not significantly impacted by boron even at a high concentration.

### Example 6

Experiment 8 constitutes Example 6, and its results indicate that HEC's viscosity is not negatively impacted by the presence of a high concentration of boron.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. Further, it is intended that the appended claims do not limit the scope of the above disclosure, and can be amended to include features hereby provided for within the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number or any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

What is claimed is:

1. A method of treating a subterranean formation adjacent a wellbore using a boron-laden fluid, comprising:
obtaining a treatment fluid comprising the boron-laden fluid and a hydratable non-galactomannan polymer; and
injecting the treatment fluid into a borehole to contact at least a portion of the subterranean formation.

2. The method of claim 1, furthering comprising adding to the treatment fluid a crosslinking agent for crosslinking the hydratable polymer and optionally a crosslinking delaying agent for delaying crosslinking of the crosslinking agent with the polymer; and crosslinking the polymer, forming a crosslinked fluid.

3. The method of claim 2, wherein the crosslinking agent is at least one of a zirconium-based and a titanium-based agent.

4. The method of claim 2, further comprising adding to the treatment fluid a breaking agent for breaking the crosslinked fluid.

5. The method of claim 1, wherein a boron concentration of the boron-laden fluid is at least about 10 ppm.

6. The method of claim 1, wherein a boron concentration of the boron-laden fluid is at least about 20 ppm.

7. The method of claim 1, wherein a boron concentration of the boron-laden fluid is at least about 40 ppm.

8. The method of claim 1, wherein the boron-laden fluid comprises at least a portion of at least one of a surface water, an underground aquifer water, a formation water, a produced water, and a flowback water.

9. The method of claim 1, wherein the boron-laden fluid is substantially free of large suspended solids.

10. The method of claim 1, wherein the boron-laden fluid is substantially free of hydrocarbons and oil condensates.

11. The method of claim 2, wherein the crosslinked fluid maintains a viscosity of about 500 cP or greater subject to typical near wellbore shear rates.

12. The method of claim 2, wherein the crosslinked fluid maintains a viscosity of about 1000 cP or greater subject to typical near wellbore shear rates.

13. The method of claim 1, wherein the hydratable non-galactomannan polymer is a cellulosic polymer.

14. The method of claim 1, wherein the hydratable non-galactomannan polymer is carboxymethyl cellulose, salts thereof, or mixtures thereof.

15. The method of claim 13, wherein the boron-laden fluid comprises at least a portion of at least one of a formation water, a produced water, and a flowback water.

16. The method of claim 14, wherein the boron-laden fluid comprises at least a portion of at least one of a formation water, a produced water, and a flowback water.

17. The method of claim 13, wherein a boron concentration of the boron-laden fluid is at least about 10 ppm.

18. The method of claim 15, wherein a boron concentration of the boron-laden fluid is at least about 10 ppm.

19. The method of claim 12, wherein the hydratable non-galactomannan polymer is a cellulosic polymer.

20. The method of claim 19, wherein the boron-laden fluid comprises at least a portion of at least one of a formation water, a produced water, and a flowback water.

21. The method of claim 20, wherein a boron concentration of the boron-laden fluid is at least about 10 ppm.

22. A method of viscosifying a boron-laden fluid comprising:
providing the boron-laden fluid;
contacting the fluid with a hydratable non-galactomannan polymer to form a base gel.

23. The method of claim 22, furthering comprising adding to the boron-laden fluid a crosslinking agent for crosslinking the hydratable polymer and optionally a crosslinking delaying agent for delaying crosslinking of the crosslinking agent with the polymer; and crosslinking the polymer within the base gel, forming a crosslinked fluid.

24. The method of claim 23, wherein the crosslinking agent is at least one of a zirconium-based and a titanium-based agent.

25. The method of 22, wherein a boron concentration of the boron-laden fluid is at least about 10 ppm and the hydratable non-galactomannan polymer is carboxymethyl cellulose, salts thereof, or mixtures thereof.

26. A method of delivering proppants using a fluid base that is boron-laden comprising:
providing a boron-laden fluid;
viscosifying the boron-laden fluid by contacting said fluid with a hydratable non-galactomannan polymer and a crosslinking agent, forming a crosslinked fluid;
suspending the proppants with the crosslinked fluid, wherein the crosslinked fluid is pumped into a wellbore adjacent to a subterranean formation; and
transporting the proppants to fractures formed by the crosslinked fluid within the formation.

27. The method of claim 26, wherein the crosslinking agent is at least one of a zirconium-based and a titanium-based agent.

28. The method of 26, wherein a boron concentration of the boron-laden fluid is at least about 10 ppm and the hydratable non-galactomannan polymer is carboxymethyl cellulose, salts thereof, or mixtures thereof.

29. A viscosified composition formed according to the method of claim 23, comprising:
a boron-laden fluid;
a hydratable non-galactomannan polymer; and
a crosslinking agent.
